(19) United States
(12) Patent Application Publication
(10) Pub. No.: US 2013/0228397 A1
(43) Pub. Date: Sep. 5, 2013

(54) WIND TOWER MAINTENANCE PLATFORMS AND TECHNIQUES

(71) Applicant: Tom D. Horn, Austin, TX (US)

(72) Inventor: Tom D. Horn, Austin, TX (US)

(21) Appl. No.: 13/411,129

(22) Filed: Mar. 2, 2012

(51) Int. Cl. B66B 9/00; B66D 1/60; E04G 3/28

(52) U.S. Cl. 182/141; 187/239; 414/800

(57) ABSTRACT

Provided herein are wind turbine tower assembly and maintenance systems and schemes. In particular, wind tower maintenance platforms are provided in order to allow service personnel to perform assembly and maintenance tasks on wind turbine towers. Some platforms disclosed herein adjust to the outer diameter of the tower, which varies tuned to the general conical shape of the tower. Other platforms provide a platform shape that allows the platform to encircle both the tower and wholly or partially encircle the turbine blade to allow personnel easy access to the blade. Other variations disclosed herein provide powerful climbing mechanisms to allow the turbine service platform to externally climb the tower carrying service personnel, parts, or even turbine blades. Gripping or braking mechanisms are provided to secure the service platform to the tower. A system is provided for lowering or raising turbine blades to and from the hub without requiring a crane.

### FIELD OF THE INVENTION

The present invention relates to wind turbine tower maintenance and construction, and more particularly to a maintenance platform.

### BACKGROUND

Wind turbines have received increased attention as inexpensive and environmentally safe alternative energy sources. Construction and maintenance of wind turbines is complicated by the increases in wind turbine size, complexity, and automation. Regarding turbine construction, a wind turbine includes a rotor having two or more blades, the rotor being mounted to a housing or nacelle mounted on top of a tower. Turbines used in wind farms for commercial electricity production are usually three-bladed, horizontal-axis wind turbines (HAWT). The blades (which are usually light gray to blend with the clouds) range in length from 20 to 40 meters or more, and sweep a vertical area approximately twice a single blade length. The typical rotation rate is 10 to 22 revolutions per minute. A gear box is commonly used to step up the speed of the generator, although some designs use a direct drive. The tubular steel towers typically range from 60 to 90 meters tall, although larger systems with multiple mega-watt outputs can be even taller. The tube shape of the tower is generally tapered. The typical commercial wind farm uses variable-speed turbines to achieve maximum efficiency. A solid-state power converter interfaces to the transmission system. The turbines also include auxiliary systems such as shut-down features to avoid damage at high wind speeds, and computer-controlled motors to point the turbine into the wind. Power production for a wind turbine is negatively impacted if the blades are not optimally maintained.

HAWTs are difficult to install, requiring tall and expensive cranes and highly skilled operators. Blade maintenance is often performed by removing the blade and laying it flat on the ground, an expensive process that uses two cranes. Further, the large and heavy bearing that holds the turbine shaft is subject to stresses from asymmetric or irregular wind pressure on the blades created in the portion of the swept area aligned with the tower. The bearings therefore need frequent maintenance or replacement.

One difficulty associated with wind turbine maintenance is the poor accessibility of the nacelle area at the top of the tower. Wind towers almost universally lack elevators, and therefore access to the top is achieved through an arduous ladder or winding staircase inside the tower, or a dangerous climbing rig or crane outside the tower.

Another difficulty of wind turbine maintenance is the extant wind conditions. Often, maintenance crews of several men and two cranes must sit for hours or days waiting for the wind velocity to abate to levels allowing safe access or removal of rotors or blades.

Another difficulty in providing wind farm maintenance is site economics. The minimum wind farm size needed to be capital-efficient is about a 20 megawatt farm, which might contain, for example, fourteen 1.5 megawatt towers (a common size), or twenty 1 megawatt towers. While such arrangement is capital-efficient, it is not, however, maintenance efficient. Purchasing a dedicated crane for maintenance of the site would be expensive, and the crane would spend much of its service life idle. However, transporting a crane from a central depot or a maintenance contractor is expensive and time-consuming, especially for one-off maintenance issues, and may have additional difficulties due to limited site access.

### SUMMARY OF THE INVENTION

Provided herein are wind turbine tower assembly and maintenance systems and schemes. In particular, wind tower maintenance platforms are provided in order to allow service personnel to perform assembly and maintenance tasks on wind turbine towers. Such tasks include tower surface maintenance, turbine blade surface maintenance such as cleaning and patching, turbine blade replacement or disassembly, turbine bearing replacement, and replacement of other parts of the nacelle or turbine assembly. Some platforms disclosed herein adjust to the outer diameter of the tower, which varies tuned to the general conical shape of the tower. Other platforms provide a platform shape that allows the platform to encircle both the tower and wholly or partially encircle the turbine blade to allow personnel easy access to the blade. Other variations disclosed herein provide powerful climbing mechanisms to allow the turbine's service platform to externally climb the tower carrying service personnel, parts, or even turbine blades. Gripping or braking mechanisms are provided to secure the service platform to the tower.

In one form of the invention, a tower maintenance platform is provided including a tower climbing vehicle with a platform for carrying a payload. The platform including a central opening designed to fit around a tower's central column, the platform including a first gripping device adapted to removably secure the platform to the tower central column. A support assembly includes a second gripping device adapted to removably secure the support assembly to the tower central column. The platform includes at least one mechanical lifting device connected between the platform and the support assembly, the mechanical lifting device adapted to lift the platform in a first lifting motion away from the support assembly to achieve an expanded position, the mechanical lifting device further adapted to lift the support assembly in a second lifting motion toward the platform to achieve a contracted position. In some variations, the first gripping device is an iris clamp. Such a device may include a plurality of claim blades driven by respective hydraulic pistons. In other variations, the gripping device is cables (wire ropes) which pass around the tower and are tightened by adjustable winches as the platform ascends to heights with smaller tower diameters. In some variations, the mechanical lifting device comprises at least one scizzor-lift jack. The platform may include a deck adapted to carry the payload, the deck further adapted to move, expand, or extend toward the tower central column to close a gap between the deck and the tower central column created by the vehicle climbing to a height where the tower central column is narrower than it is at a base height.

In one preferred embodiment, the maintenance vehicle is provided with a deck having fittings adapted to carry wind turbine bearings to the top of wind towers. In another embodiment, the platform is provided with a clamping mechanism adapted to clamp to a turbine blade and carry it up and down the tower.

In some embodiments, the platform is provided for carrying a payload, the platform including a central opening designed to fit around a wind tower and a mechanical clamping and lifting arrangement provided about the central opening of the platform. The mechanical clamping and lifting arrangement adapted to lift the platform while maintaining an inward clamping pressure against the wind tower exterior. Such a platform may include a deck adapted to carry the payload, the deck further adapted to move, expand, or extend toward the tower central column to close a gap between the deck and the wind tower created by the vehicle climbing to a height where the wind tower is narrower than it is at a base height. The mechanical clamping and lifting arrangement may further include a set of wheels adapted to apply the clamping pressure against the wind tower exterior and adapted to rotate to lift the tower. The set of wheels may include multiple groups of wheels, each group positioned at a different circumferential position about the central opening, each group including at least an upper wheel and a lower wheel positioned vertically below the upper wheel. Further, the set of wheels may be adapted to move inward in a radial direction relative to the wind tower in order to maintain pressure on the wind tower exterior as the vehicle climbs the wind tower. Other embodiments may use gear wheels adapted to match gear tracks provided along the surface of the tower in order to climb the tower.

In some embodiments, a gap formed in the platform in a position to allow the platform to pass a wind turbine propeller blade held in a vertical position. This may be provided in a manner allowing the platform to climb to the top of the tower, immediately below the nacelle, which position might, for some wind tower designs, be inaccessible to other maintenance platforms of similar size. And the platform and gap may also be provided to allow maintenance personnel a surface or deck position next to or around the turbine blade surfaces to allow access for maintenance and repair of the surfaces without removing the turbine blades. In some versions, the gap is further adapted to allow passage of wind turbine propeller blades while the propeller is rotated.

In another embodiment, the invention provides a method of servicing a wind turbine tower. The method includes, encircling a base of the wind turbine tower with a climbing vehicle. Next the method secures a replacement wind turbine bearing to the climbing vehicle. Then, the vehicle is operated to climb the wind turbine tower carrying the replacement bearing. After this, the method detaches the replacement wind turbine bearing from the climbing vehicle. Next, the method installs the replacement wind turbine bearing in a wind turbine while the wind turbine is positioned at the top of the wind turbine tower.

In some embodiments of the invention, the platform includes multiple platform segments having an interior curved edge designed to match the wind turbine tower exterior at a point where the climbing vehicle is at its maximum elevation.

In still other embodiments, the climbing vehicle is adapted to be placed in a first base configuration in which the multiple platform segments are separated from each other and a second ascended configuration in which the multiple platform segments are joined.

It may be understood from this disclosure that the features herein may be used together in the same service platform, in any functional subcombination. More particularly, this description should be interpreted by those of skill in the art to provide a written description supporting a set of multiple dependent claims such as is commonly employed in European patent practice, for example. That is, all features described in this application that are not mutually exclusive to each other may be used together in any functioning subcombination.

### BRIEF DESCRIPTION OF THE DRAWINGS

FIG. 1A shows a wind tower with a climbing platform positioned around its base.

FIG. 1B shows a climbing platform in operation using a telescoping climbing principle.

FIG. 2A shows a climbing platform having separated segments for encircling a tower at its larger base circumference.

FIG. 2B shows a climbing platform having joined segments for encircling a tower at its smaller top circumference.

FIG. 3 shows an embodiment of a track-driven climbing platform.

FIGS. 4A-B shows an embodiment of a wheel-driven climbing platform.

FIG. 5 shows an embodiment of a gear-driven climbing platform.

FIG. 6A shows a front view of a turbine upper section with a lifting truss installed.

FIG. 6B shows a side view of the same turbine with the lifting truss installed.

FIGS. 7A-B show a horizontal cross-section view of a lifting platform with an iris brake encircling the base of a tower (7A) and the top of a tower (7B).

FIG. 7C shows a vertical cross-section of a lifting platform with an iris brake encircling a tower.

FIGS. 8A-B show a horizontal cross-section view of an iris brake in operation.

FIG. 9 shows a climbing platform having a clamping device for carrying a turbine blade.

FIGS. 10A-B show a service platform including a gap or cutout provided to allow the platform to encircle or partially encircle a turbine blade.

FIGS. 10C-E show a service platform with overlapping segments that adjust to provide room for the blade at the platforms highest elevation.

FIG. 11 is a cutaway diagram of a wind turbine including a system for raising and lowering the turbine blades according to another embodiment.

FIG. 12 is the same view as FIG. 11 shown with the blade lowering process partially complete.

FIG. 13 is a cutaway view of a wind turbine with an alternate system for raising and lowering the blade, with a winch assembly being placed inside the tower nacelle.

FIG. 14 is a cutaway view of a wind turbine with another alternate system for raising and lowering the blade, with the winch assembly being placed inside the propeller hub.

FIG. 15 is a cutaway view of a propeller hub showing a pulley assembly according to one embodiment.

FIG. 16 is a cutaway view of a propeller hub showing a winch assembly according to another embodiment.

FIG. 17 is a flowchart of a process for lowering a turbine blade according to one embodiment.

FIG. 18 is a flowchart of a process for raising and attaching a turbine blade according to one embodiment.

### DETAILED DESCRIPTION OF PREFERRED EMBODIMENTS

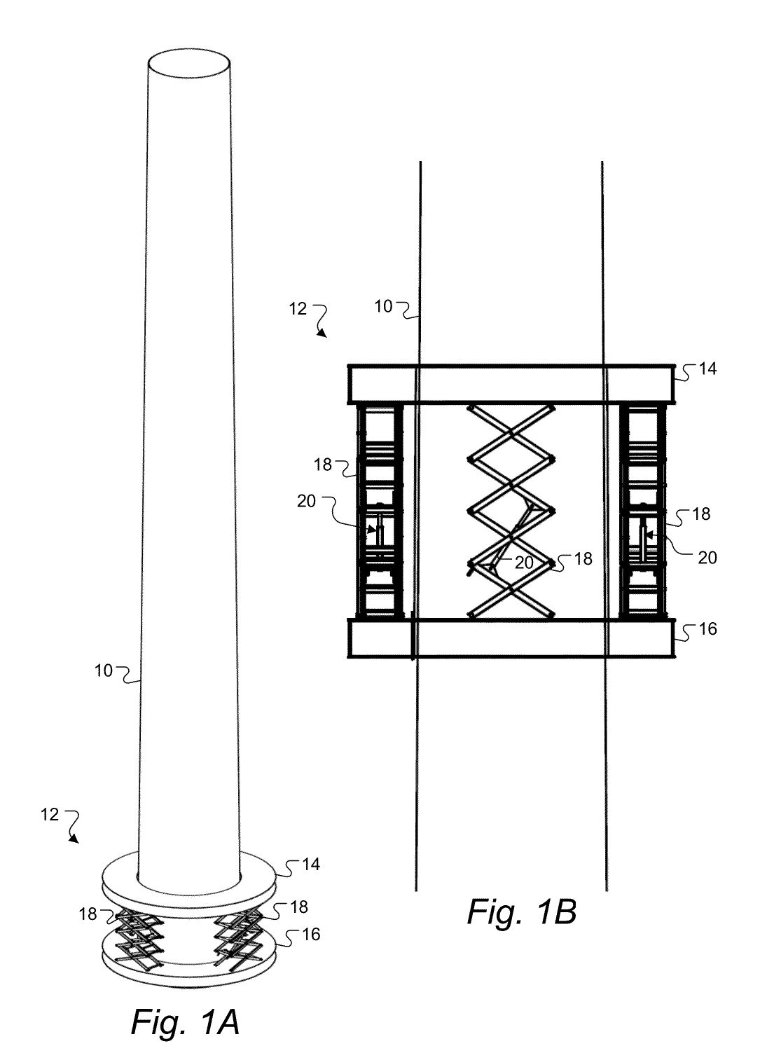

FIG. 1A shows a wind tower with a climbing maintenance platform positioned around its base. The tubular tower 10 is shown for simplicities sake without a rotor or nacelle attached to the top. The climbing platform 12 is shown positioned at the bottom of tower 10. Platform 12 has an upper deck 14 and a lower deck 16. Upper deck 14 is used in this embodiment to carry passengers or equipment up the tower, while lower deck 16 may also carry equipment but is primarily used to achieve the climbing function of platform 12. Platform 12, in this embodiment, climbs using hydraulically driven scissor lifts 18. These lifts are further shown in FIG. 1B, which shows a climbing platform 12 in operation using a telescoping climbing principle. Scissor lifts 18 are shown having hydraulic pistons 20 attached thereto to provide motive force to the platform. The platform 12 climbs by clamping lower deck 16 to tower 10, then extending scissor lifts 18, then releasing lower deck 16 and clamping upper deck 14 to the tower, and then retracting scissor lifts 18, pulling lower deck 16 upward so the process can be repeated. In this manner, climbing platform 12 shimmies up the tower. It is understood that hydraulically driven scissor lifts is merely one method of moving the climbing platform 12, and other embodiments may use other methods of motive force. For example, hydraulic pistons may directly connect the two decks 14 and 16 to achieve the push/pull motive force. Further, other embodiments may use a single deck rather than an upper and lower deck. Lifting may be achieved in a conventional manner through a rope, chain, or line attached or draped over the tower top and climbed with a hoist on the platform. Other climbing methods are described herein.

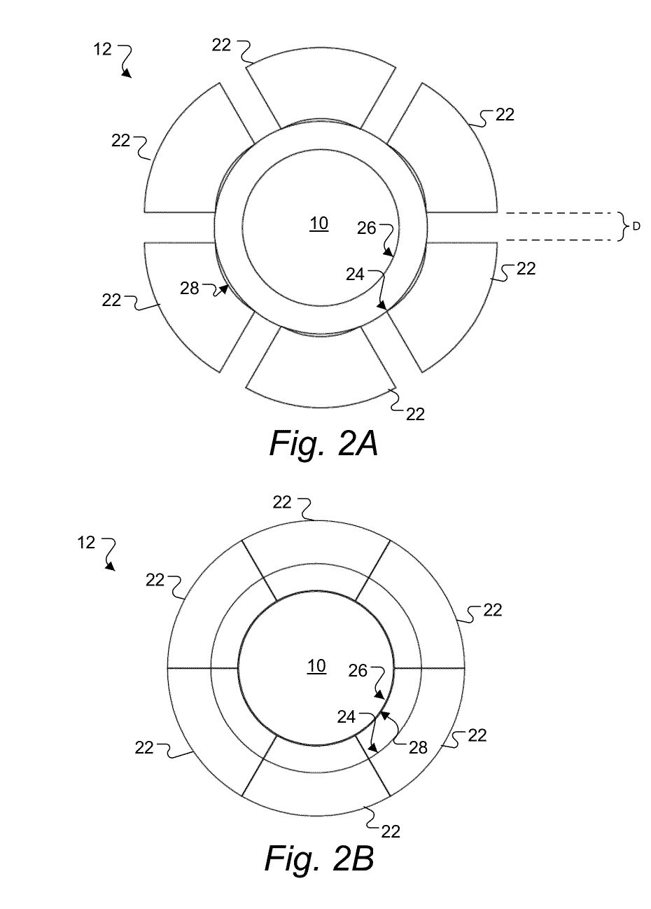

FIG. 2A shows a climbing platform 12 having separated segments for encircling a tower 10 at its larger base circumference 24. FIG. 2B shows a climbing platform 12 having joined segments for encircling a tower 10 at its smaller top circumference 26. In preferred versions of the climbing platform herein, a climbing platform (whether it has one or two decks) is enabled to adjust to the varying circumference of the tapered tower by having separable segments 22, joined by a framework of rods (not shown) which retract into each segment 22 as the platform climbs and the distance between the segments is reduced to accommodate the shrinking tower circumference. To begin servicing a tower, platform 12 is placed around the tower base circumference 24, preferably using a hinged arrangement that separates the platform into two half circles which may be hinged or otherwise joined around the base 24 of the tower. When so placed, platform 12 is initiated in a first, separated configuration such as that shown in FIG. 2A. The inner curved edge 28 of the platform segments 22 is preferably adjacent or near the tower edge as depicted in FIG. 2A. Notice that each platform segment 22 preferably has an inner surface with a curved edge 28 matched to the towers top circumference 26. The platform 12 then begins climbing (or is raised with conventional hoists) up the tower. As it climbs, the distance D between segments 22 is gradually reduced to keep segments 22 near the tower wall. Structural integrity may be provided by a circular frame to which the segments 22 are movably connected, the circular frame having a larger circumference than the outer circumference of tower 10.

Upon reaching the top, platform 12 has contracted to the second configuration shown in FIG. 2B, wherein the curved edges 28 of each deck are adjacent or near the tower wall at its top circumference 26. In the second configuration, the lateral sides of segments 22 are now joined together to present a continuous deck upon which personnel and equipment may move freely.

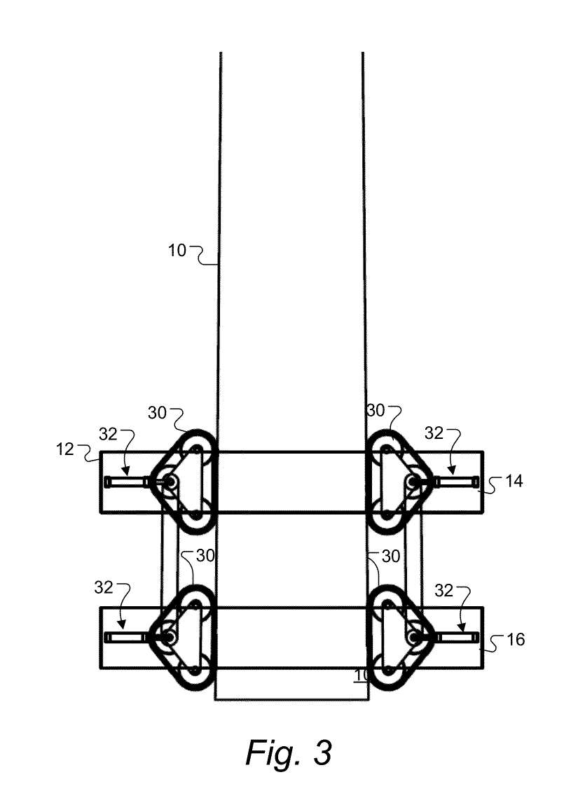

FIG. 3 shows an embodiment of a track-driven climbing platform 12. In the depicted embodiment, two decks 14 and 16 are driven up the tower 10 by track drives 30. Pressure is applied to the tower wall through the track surface by hydraulic pistons 32. While the depicted configuration uses a platform with two decks, with this climbing method a one deck platform may also be used. In such a case, a single track drive 30 may have two pistons 32 pressing it against the tower surface in vertically separated locations. Preferred embodiments of the depicted track drive platform use at least four track drives positioned equidistantly around the deck.

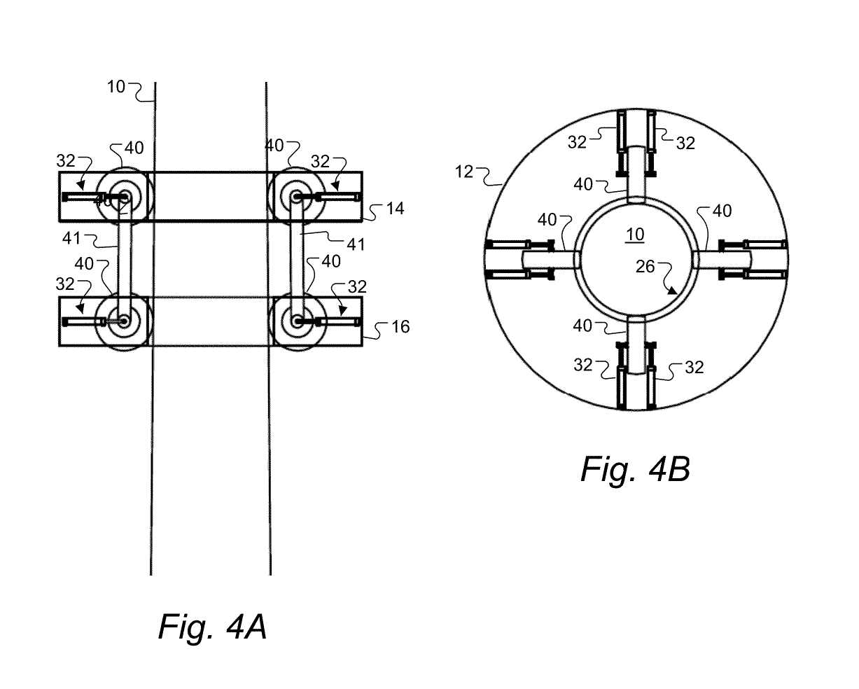

FIGS. 4A-B show an embodiment of a wheel-driven climbing platform 12. In this embodiment, wheels 40 are driven to move platform 12 up and down the tower 10. While the depicted configuration uses a platform with two decks 14 and 16, with this climbing method a one deck platform may also be used. The deck 14, 16 may be a simple round disk with a hole in the center, likened to the floor of a carousel, or may include multiple deck sections as described herein. The deck 14, 16 may be made of carbon fiber reinforced polymers to provide light weight, or aluminum, steel, or other suitable construction material. It is driven up the tower by four symmetrically embedded mounted drivers 32. In one version, wheels 40 are mounted to adjustable trunnions rather than to the depicted straight vertical braces 41. Four tower drivers, which operate to push wheels 40 against the wind tower 10 at its base, are held in place by a bay or slot for each in the inner circle of the disk. The trunnion pivots of each drive are tightened or loosened to maintain the friction for driving or braking. The power is hydraulic motors, the transmission is a worm drive, the wheels and brakes may be constructed with small jet aircraft landing gear wheels and tires.

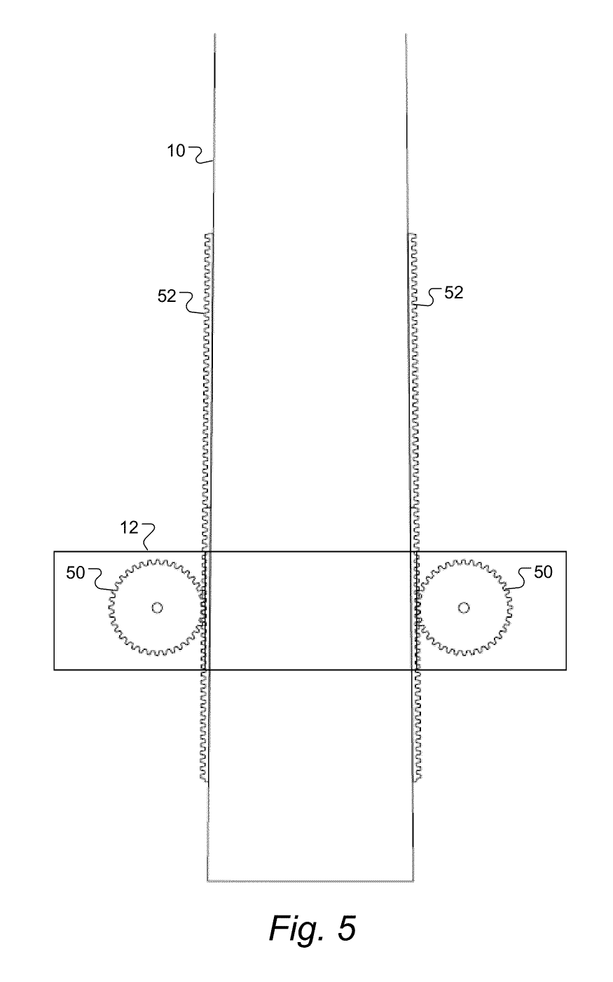

FIG. 5 shows an embodiment of a gear-driven climbing platform. In this embodiment, the tower 10 must be fitted with climbing tracks 52 which present gear teeth outwardly along the tower surface. On the platform 12, corresponding gear wheels 50 are provided to match the teeth of the tracks 52, giving the platform purchase with which to ascend and descend the tower 10. Preferably, in embodiments using such a gear wheel arrangement, the wheels 50 are moved inward as the platform ascends the tower and the tower radius shrinks, as described herein as a feature of the conical shape of many modern wind towers.

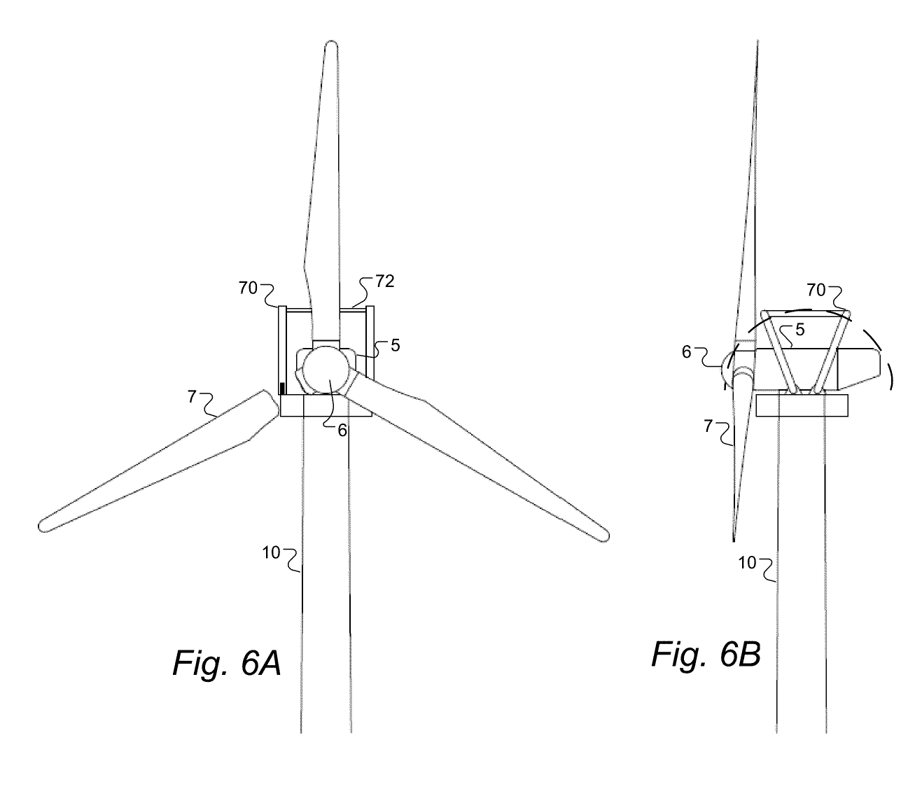

FIG. 6A shows a front view of a turbine upper section with a lifting truss 70 installed. FIG. 6B shows a side view of the same turbine with the lifting truss 70 installed. Dotted lines depict the range of movement for lifting truss 70 on its pivoting mounts. Preferably, movement is accomplished through a pivot control cable attached to the back of the truss to a hoist on the ground. Lifting with the truss is then accomplished through one of more lifting cables run over pulleys, preferably positioned in the center of the front cross-support 72. The truss can be used for various heavy lifting jobs involved in tower construction and maintenance. For example, the nacelle 5 may be lifted into place from ground level by moving the truss with the pivot control cable to a forward leaning position, attaching nacelle 5 to the lifting cables, and raising it with a hoist until nacelle 5 is vertically above its mounting point atop the tower 10. Then the pivot control cable is used to pivot truss 70 toward the rear of the tower until the nacelle is over its mounting position, suspended inside of the truss 70 framework, from where it is lowered and adjusted into its final mounted position. Given that a nacelle typically extends further off the back of the tower than the front, the operation described above can also be reversed and conducted by lifting nacelle 5 up the back side of the tower.

The rotor blade assembly 6 may be lifted and mounted by following the same steps above, with its rotor blades 7 already attached. Alternatively, the blades may be lifted with the truss and mounted separately.

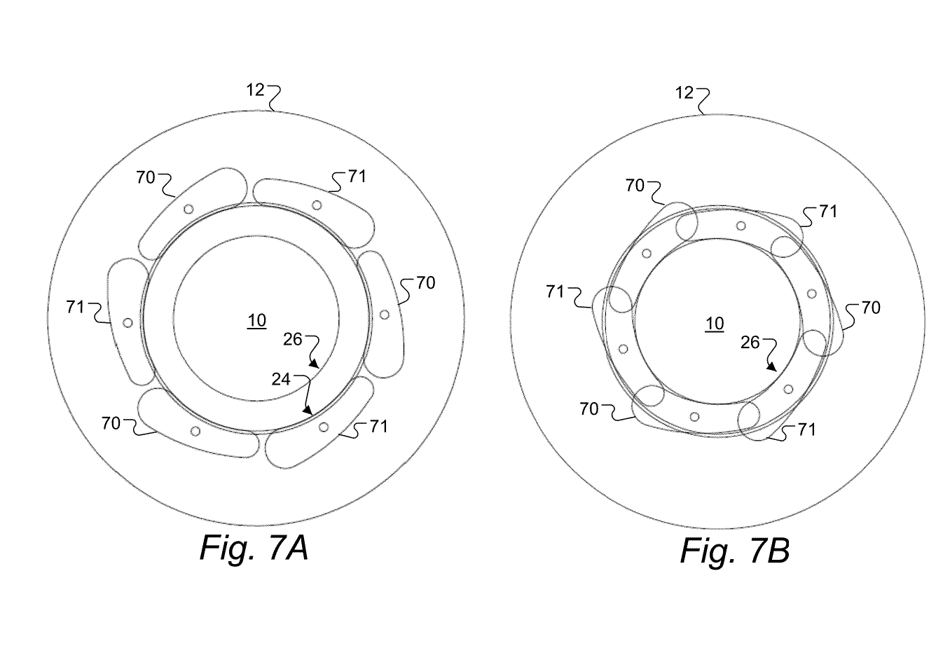

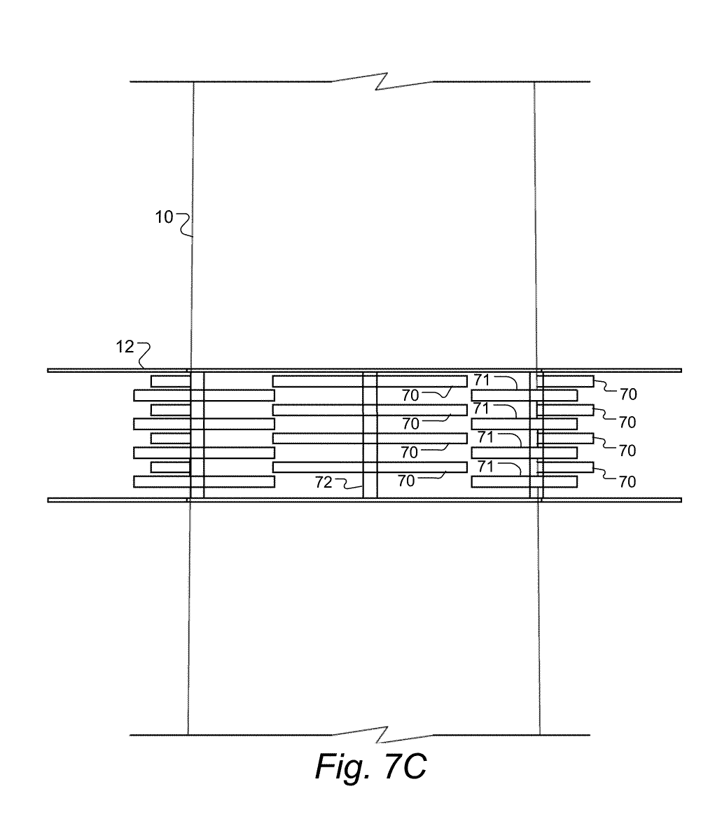

FIGS. 7A-B show a horizontal cross-section view of a lifting platform 12 with an iris brake encircling the base of a tower 10 in (FIG. 7A) and the top of a tower 10 (FIG. 7B). Only portions of the platform are shown in order to simplify the drawing. The platform 12 is provided with an iris brake including iris blades 70 and 71. In FIG. 7A, the brake is in an expanded configuration positioning blades 70 and 71 around the base of the tower 10. To provide braking force against the tower, the blades 70, 71 are forced inward to clamp the tower. FIG. 7C shows a vertical cross-section of a lifting platform 12 with an iris brake encircling the tower 10. A cross-section of iris blades 70 and 71 is visible, with the driving mechanism not shown to simplify the drawing. Iris blades 70 and 71 are shown in cross-section with a central blade mounting piece 72 depicted passing through the body of blades 70 or 71. A mounting piece 72 is provided in each vertically adjacent group of blades 70 or 71 to connect the blades to platform 12. Preferably, the inside surface of the blades 70 and 71 (adjacent the tower) is slanted at an angle from vertical in order to match the angle of the tapering surface of tower 10. The particular taper angle varies among towers but is typically over 1 degree and frequently about 2 degrees off of vertical.

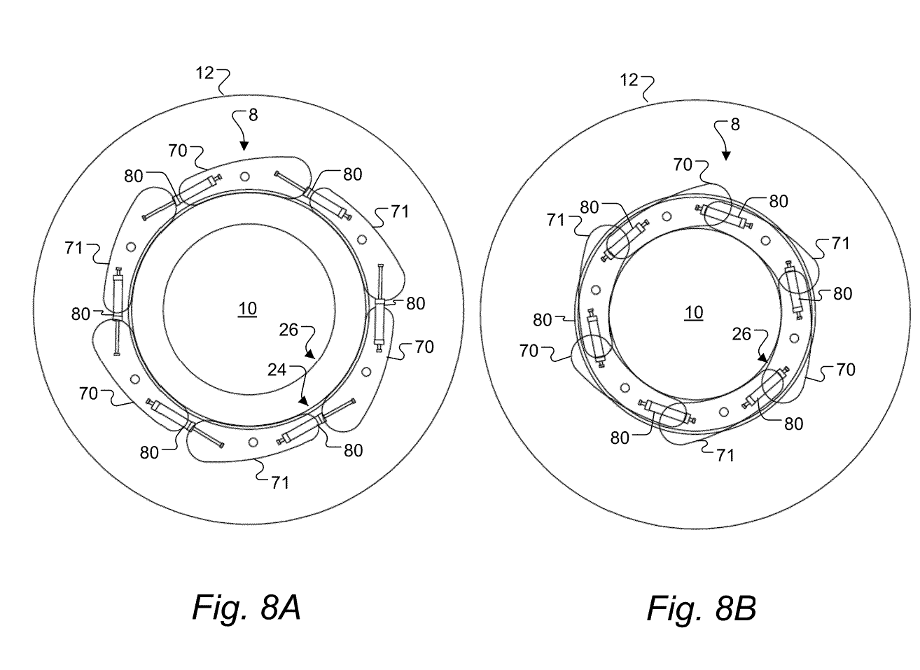

FIGS. 8A-B show a horizontal cross-section view of an iris brake 8 in operation. In this embodiment, a platform 12 having an iris brake 8 is depicted in a first expanded position in FIG. 8A and a second, contracted position in FIG. 8B. Referring to FIG. 8A, the platform 12 is shown in a horizontal cross-sectional view encircling a tower 10, having upper circumference 26 and lower circumference 24. The platform 12 is provided with iris blades 70 and 71 which are employed to apply braking pressure to the tower 10 surface, holding the platform 12 in place. If a dual-deck design such as that depicted in FIGS. 1A-B is used, each deck is preferably provided with an iris brake.

In operation, the depicted iris brake 8 clamps and releases its host platform to the tower surface contracting the interior circumference of the iris formed by the interior of blades 70 and 71. The contracting and expanding force is accomplished, in this embodiment, through hydraulic pistons 80, which connect adjacent pairs of iris blades 70 and 71. Hydraulic pistons 80 are two-way pistons having opposing hydraulic chambers allowing opening and closing with hydraulic force. In order to allow the platform 12 to climb, a platform deck, which has iris brake 8 encircling the base of tower 10 as depicted in FIG. 8A, slightly relaxes the pistons 80 to allow a clearance between iris blades 70 and 71 and the surface of tower 10. When the iris brake is elevated to a level where it is required to grip the tower, contractive force is applied to hydraulic pistons 80, the inner circumference formed by the blades 70 and 71 to grip the tower.

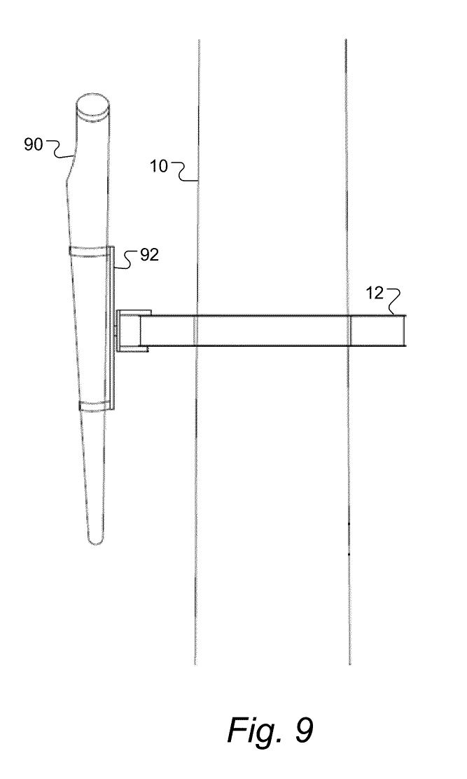

FIG. 9 shows a platform 12 according to another embodiment. In the depicted embodiment, the platform is outfitted with a dual clamping arrangement 92 able to carry a single turbine blade 90 up and down the tower 10. To simplify the drawing, the depicted platform 12 is shown without means of ascending and descending the tower. Any suitable method described herein or other known methods, such as a winch system deployed with cables stretching to the top of the tower, may be used to move platform 12. The dual clamping arrangement 92 is employed, in this embodiment, to assist in the maintenance process of turbine blades by removing the blade from its position on the turbine and carrying it down the tower for maintenance on the ground. Such a process avoids the traditional method of removing the entire propeller assembly, which has an immense weight when carrying all three turbine blades, using a crane.

In use, maintenance personnel perform the blade removal process by ascending tower 10 using platform 12, with the propeller in a braked and locked position with the targeted blade pointing directly downward, and the other two blades fixed in a balanced position. The remaining two blades may also be rotated to provide minimal, or even opposing, wind torque forces in order to prevent the partially disassembled propeller from rotating. When the platform 12 has reached a height equal to the blade mass midpoint, the platform is halted and the dual clamping arrangement is employed to grasp the blade. In this embodiment, the dual clamping arrangement 92 is provided with two clamps or clasps with which to grasp the blade 90. In some embodiments, platform 12 may extend toward and around the blade in order to allow operator access to attach the clamps of dual clamping arrangement 92. In a preferred embodiment, the clamps are band clamps including a band and a securing and tightening mechanism for encircling and firmly grasping the blade. As depicted, the dual clamping arrangement 92 grasps the blade 90 on both sides of the blade mass midpoint. This allows for stable movement. The process preferably includes a step of testing whether the clamps are properly configured to bear the full load of the blade 90. For example, the test may include measuring a load transferred to the platform along with the clamping mechanism. As an alternative or backup blade carrying mechanism, a cable and winch combination may be used to lower the blade from the propeller assembly, guided by the clamping arrangement 92 to prevent blade 90 from swaying dangerously in the wind.

The dual clamping arrangement 92 is fixed or extends laterally from the edge of platform 12 proximal to the propeller. In some versions, dual clamping arrangement 92 may be extendable outwardly from the platform, or may be an accessory that can be fixed in place at the edge of the platform. While a rigid clamping arrangement is shown, other versions may employ a series of tightening bands and cables to secure the blade 90, particularly when the platform is assisted in bearing the load of blade 90 using a cable or winch system to suspend blade 90 from the propeller assembly while blade 90 is lowered.

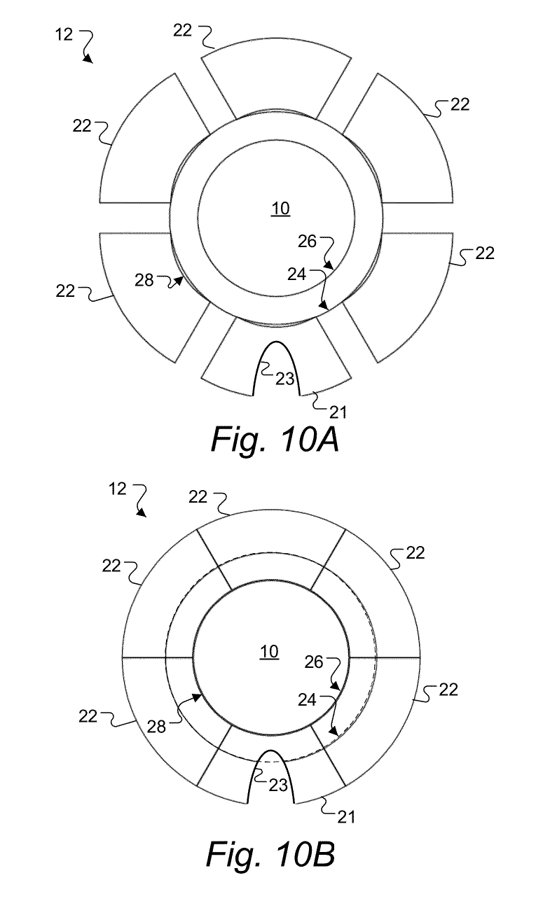

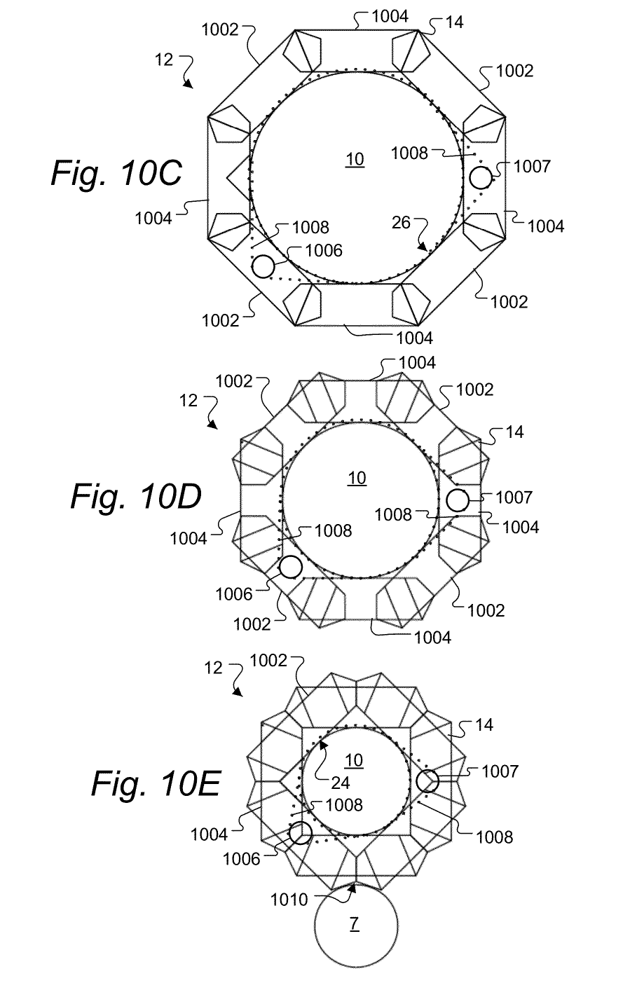

FIGS. 10A-B show a top partial view of a segmented platform 12 having a gap or cutout portion 23 in one of the segments 21 designed to accommodate a turbine blade to provide freedom of movement to the platform or improved access to the blade for maintenance. FIG. 10A shows a climbing platform 12 having separated segments 21 and 22 for encircling a tower 10 at its larger base circumference 24. FIG. 10B shows a climbing platform 12 having joined segments 21 and 22 for encircling a tower 10 at its smaller top circumference 26. In operation, the depicted platform 12 works similarly to that in FIGS. 2A-B. As the platform ascends, the tower segments 21 and 22 move together to accommodate the reduced tower diameter. The depicted cutout portion 23 is formed, in this embodiment, by one segment 21 of a segmented platform 12 such as that shown in FIGS. 2A-B. In other embodiments, the cutout portion 23 may be formed in other ways, such as between two segments 21, or extensions from one or two of the platform segments 21 or 22. In some embodiments, one or more segments such as the depicted segment 21 may be extended on rods and supported by cables to move the cutout portion 23 and its surrounding platform surface close to the blade when platform 12 is not positioned high enough on tower 10 to allow personnel to access the blade surface. (Despite the tower taper, blades tend to be closer to the tower at the top due to rotor tilt.) Thus, the depicted platform 12 provides a stable platform from which maintenance activities may be conducted on a blade while it is still installed on the tower 10, and allows a larger platform 12 to access the highest portions of the tower 10 than would be allowable with no cutout portion 23.

FIGS. 10C-E show schematic diagrams of a service platform 12 with overlapping segments that adjust to provide room for the blade at the platforms highest elevation. FIG. 10C shows the platform 12 in its widest configuration encircling the base circumference 26 of the tower 10. FIG. 10D shows platform 12 in a position midway up tower 10, and FIG. 10E shows platform 12 in its most contracted configuration at the highest elevation it can reach on tower 10 encircling the tower's smaller top circumference 24.

Referring now to all three of these figures, the platform 12 made include one or two decks as previously discussed, but for simplicity in the drawings we will show a schematic see-through view of a single upper deck 14. The depicted upper deck 14 includes multiple top segments 1002 and bottom segments 1004, which are connected together in an overlapping fashion. The connection may be accomplished through any suitable manner such as, for example, the use of sliding tracks in each bottom segment 1004 to which top segments 1002 are attached to move in an overlapping fashion as shown in the drawings. As shown in FIG. 10C, the segments 1002, 1004 overlap only slightly because this configuration is the largest circumference configuration. FIG. 10E shows the smallest circumference configuration, with the maximum overlap of top segments 1002 and bottom segments 1004. As shown, the top segments 1002 may be adjacent in the depicted minimum circumference configuration. Preferably, the thickness of the top segments 1002 is not so great to permit operators from stepping from segments 1002 onto segments 1004 when the top segments are not adjacent (such as in the configurations shown in FIGS. 10C-D).

Various methods of raising the platform along the tower have been described, and any suitable method may be used with the depicted platform design. For example, cables may pass from the platform over the top of the nacelle and back down allowing the platform to be raised by winches positioned on the platform. Various other climbing techniques may also be used as described herein.

The depicted platform 12 in FIGS. 10C-E includes a braking mechanism employing cables, bands, or belts 1008 (“belts 1008”, which are shown as dotted lines to clarify their position versus the other solid elements around them) which pass around tower 10 and are tightened to hold the platform 12 in place. The belts 1008 are loosened to allow the platform 12 to move, and tightened to activate the brake and hold the platform in place wherever it is on the tower. As shown, a winch and control mechanism 1006 is provided on one of the top segments 1002, and another mechanism 1007 is provided on the bottom segments 1004. The mechanism 1006 on the top segment 1002 is positioned on top of the segment, and controls belt 1008 passing around tower 10 and back to the same mechanism 1006. Similarly, the winch and control mechanism 1007 which is on the bottom segment 1004, is preferably suspended from the underside of bottom segment 1004, so that the belt 1008 which passes around tower 10 and back to mechanism 1007 does not interfere with the other belt 1008.

While only two winch mechanisms and belts are shown, this is not limiting and other versions may have multiple winch and control mechanisms on the top segments 1002, and multiple winch and control mechanisms on the bottom segments 1004. In such case, overlap or interference of multiple belts on the same side of the platform deck 14 may be avoided by positioning them at different heights or distances from the deck surface.

As can be seen in FIG. 10E, at the smallest circumference configuration of platform 12, the deck 14 is shaped such that segments 1002 which project near the blade 7 form a cutout portion 1010 allowing passage of blade 7 such that the platform does not impact or negatively interfere with the blade.

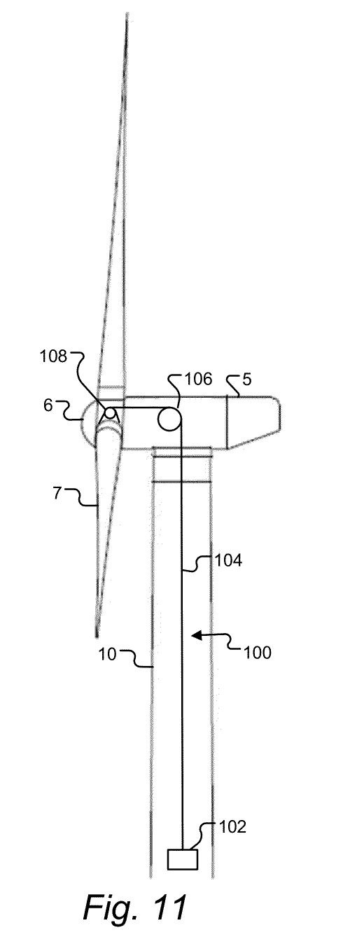

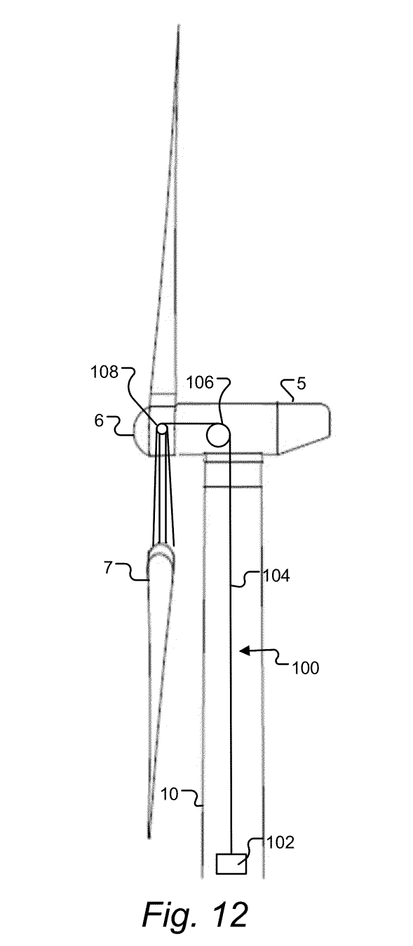

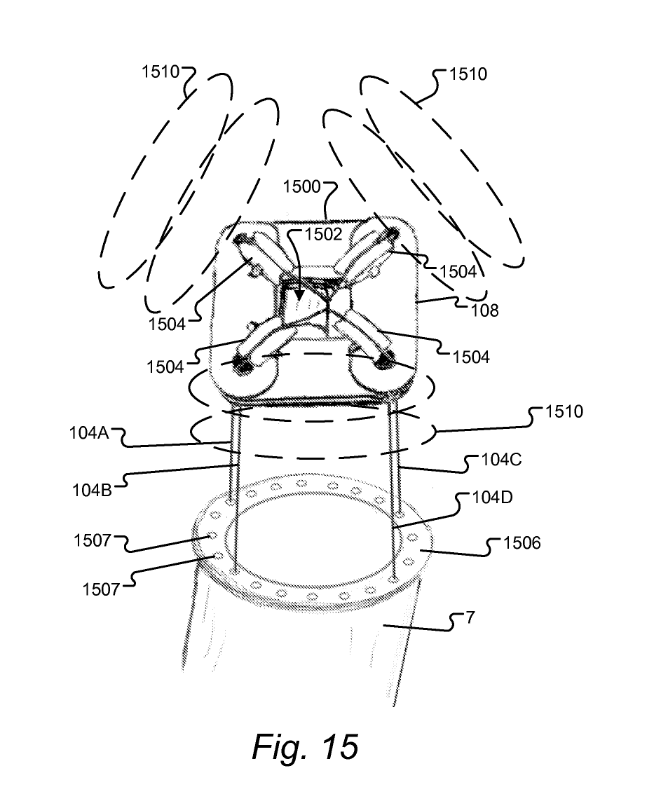

FIG. 11 is a cutaway diagram of a wind turbine 10 including a system for raising and lowering the turbine blades 7 according to another embodiment. FIG. 12 is the same view as FIG. 11 shown with the blade lowering process partially complete. Referring to both figures, the depicted wind turbine 10 includes a blade removal system 100 operable to move blades 7 from the ground into position for mounting on the hub 6, and also lower a blade from the mounted position to the ground. In this embodiment, the system 100 includes a winch assembly 102, 3 or more cables 104 (wire ropes) which pass through pulley assemblies 106 and 108 to connect to the blade 7. A preferred version uses four cables. The connections may be made to adapters provided on the mounting hardware of the blade 7, or the blade may be specially configured with connections for attaching cables 104. In the depicted version, the cables 104 are pulled by winch assembly 102 positioned inside the tower 10 at the base. After leaving the winch assembly 102, cables 104 passes up the interior of the tower 10 to pulley assembly 106, which is housed inside the nacelle 5. Pulley assembly 106 turns the cable 90° to allow it to pass to the propeller hub 6, where it goes through hub pulley assembly 108. This assembly only turns the cables 104 from its horizontal orientation as it passes through the nacelle 5, but also splits the cables 104 in different directions so that they may connect to the blade 7 at various points in order to lower the blade in a stable balanced manner. One example pulley assembly is further described with respect to FIG. 15. At the least, pulley assembly 108 includes a main pulley configured to receive all of cables 104 as they extend from pulley assembly 106, and a single directional pulley for each cable included in the group of cables 104, the directional pulley configured to receive the cable from the main pulley, and direct it to be vertically placed for connection to a designated point on the blade beneath the pulley assembly.

While the depicted configuration in FIG. 11 and FIG. 12 places the winch assembly at the base of the tower, in some towers such a placement is not feasible because the structure of the tower does not allow cables to pass unobstructed from the base into the nacelle. Other configurations are therefore possible according to the techniques provided herein.

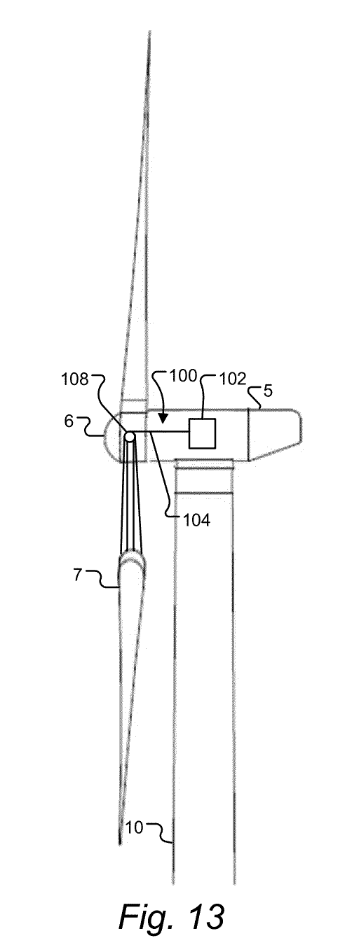

One such alternative is shown in FIG. 13, which is a cutaway view of a wind turbine 10 with an alternate system 100 for raising and lowering the blade 7, with the winch assembly 102 being placed inside the tower nacelle 5. In this embodiment, only one pulley assembly is required, the hub pulley assembly 108. As shown, the cables 104 pass from the winch assembly 102 inside the nacelle 5 to the hub pulley assembly 108. At this point, the system operates similarly to the previously described embodiments.

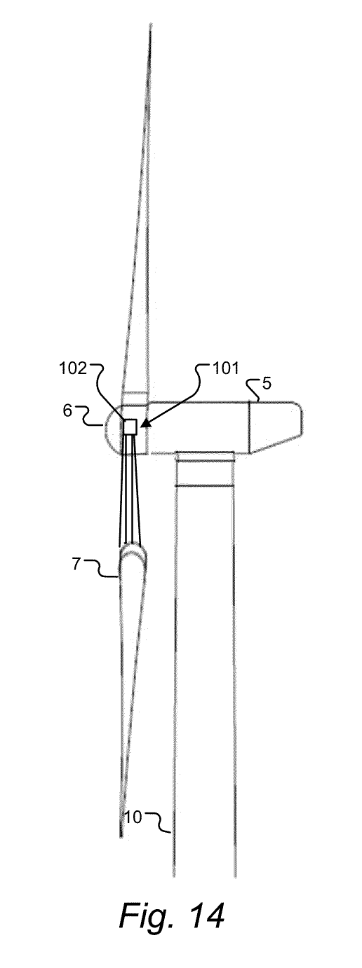

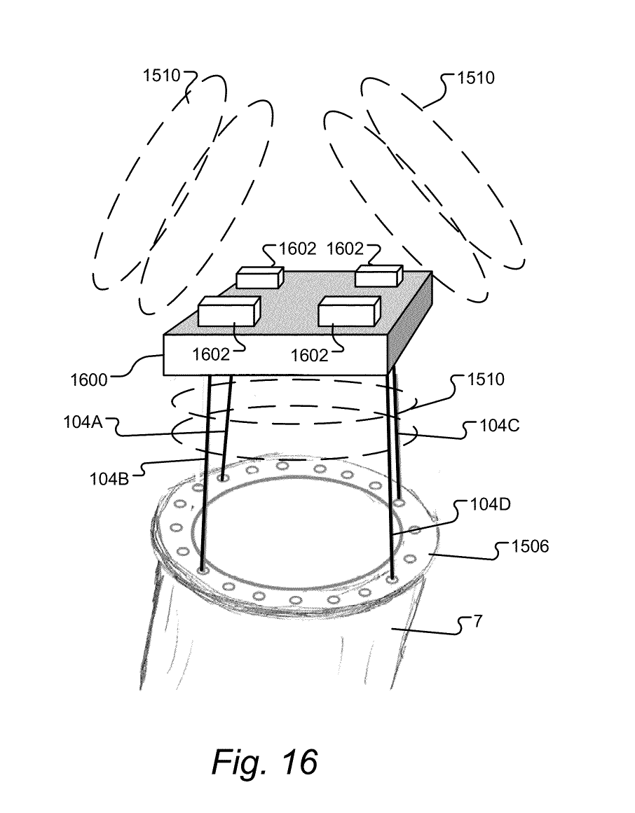

However, the configuration shown in FIG. 13 may itself not be feasible in certain common designs which place a solid gearbox between the generator area (the central part of the nacelle 5) and the hub 6. Such designs would obstruct the passage of cables from the central part of the nacelle to the center of the hub. In such cases, it may be preferable to place the winches for raising and lowering blade 7 inside of the hub 6, and configured either as a winch assembly or a plurality of individual winches controlled in cooperation to lower or raise the blade 7. FIG. 14 is a cutaway view of a wind turbine 10 with another alternate system for raising and lowering the blade 7, with the winch assembly 102 being placed inside the propeller hub 6 in this manner. One suitable winch assembly 102 for use in this embodiment is described with respect to FIG. 16.

FIG. 15 is a cutaway view of a propeller hub showing a pulley assembly 108 according to one embodiment. Each of the three depicted pairs of ovals labeled 1510 show the location of the attachment portal for one of the three blades in the rotor propeller. The structure of the hub itself is not shown in order to not obscure the pulley assembly's placement inside of the hub, however it is understood that the hub surrounds the depicted pulley assembly 108 and provides a structure in which is formed the openings that make up each blade connection portal 1510.

The depicted hub pulley assembly 108 includes a main pulley 1502 configured to receive all of cables 104 as they extend from pulley assembly 106, and a single directional pulley 1504 for each cable included in the group of cables 104, the directional pulley 1504 configured to receive the cable from main pulley 1502, and direct it to be vertically placed for connection to a designated point on the blade 7 beneath hub pulley assembly 108. In the depicted design, a support structure 1500 supports main pulley 1502 in a central opening of the support structure 1500 through which cables 104 pass. The cables are then distributed to their respective directional pulleys 1504, where they pass through portals in the support structure 1500 and are seen depicted connecting to the attachment collar 1506 of suspended blade 7 as cables 104A-D. In a preferred embodiment, each of the 4 depicted cables passes through a respective bolt-on hold surrounding the blade attachment portal 1510. This, of course, may vary depending on how the blade is attached, but the described structure is appropriate for the typical rotor propeller design in which the blade presents a series of bolts 1507 on its attachment collar which pass through a bolthole on respective face of the hub, and then provided with nuts to block the blade in place on the hub. In some situations, a designated number of those bolts on the blade attachment collar 1506 may be replaced with some modified bolt or other attachment means to allow attaching the cables 104.

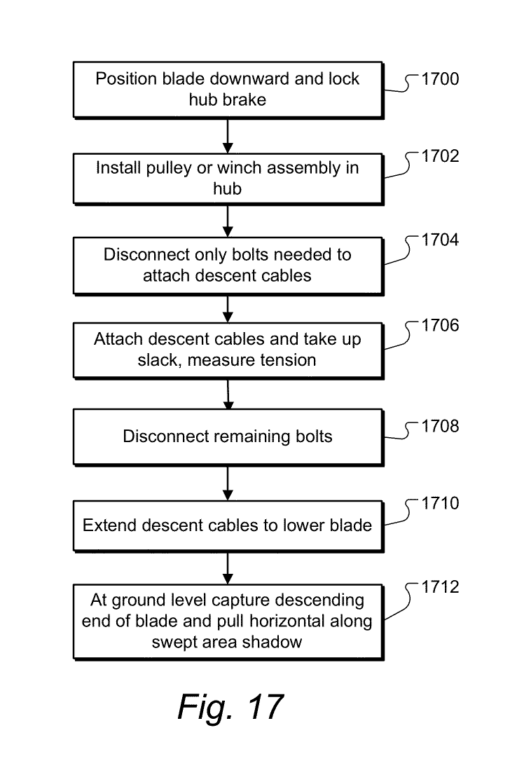

Preferably, the general support structure 1500 for hub pulley assembly 108 is configured to fit inside of the hub, and to be fixed in place in the hub suitably positioned above the blade to be lowered such that it can be used, for example, according to the process described in the flowchart of FIG. 17. In some embodiments, this may require the hub pulley assembly to include one or more subassemblies that are smaller than the final structure, allowing them to be carried into the hub area and then assembled together. As shown, the hub pulley assembly 108 support structure 1500 includes a plurality of smaller pieces, 4 of which are shown connected in a square to form the main supporting structure. In one embodiment, the structure is configured to be suspended in the hub with braces that attach to a suitable supporting structure in the hub. In other embodiments, the hub pulley assembly 108 support structure 1500 is configured such that it will rest or sit along the upper edges of the blade attachment portal 1510, and be fixed in such position.

FIG. 16 is a cutaway view of a propeller hub showing a winch assembly 1600 according to another embodiment, which is preferably used for the winch assembly 102 in systems arranged according to FIG. 14. The depicted winch assembly 1600 includes a supporting structure to which are mounted three or more winches 1602. Preferred embodiments use four winches 1602 as depicted, with four respective cables 104A-D connecting to blade 7. Preferably, the general support structure for winch assembly 1600 is configured to fit inside of the hub 6, and to be brought into the hub through an access portal to the nacelle. In some embodiments, this may require the winch assembly to include one or more subassemblies that are smaller than the final structure, allowing them to be carried into the hub area and then assembled together.

FIG. 17 is a flowchart of a process for lowering a turbine blade according to one embodiment. The process begins at step 1700, where the blade desired to be lowered is positioned downward, and the rotor hub is locked in place with the brake. Next, at step 1702, the operators install the pulley or winch assembly in the hub. A winch assembly is used if the system is arranged according to FIG. 14, and pulley assembly is used if the system is arranged according to FIG. 11 or FIG. 12. An additional pulley assembly (FIG. 12, 106) may be installed if the winch assembly is provided at the base of the tower.

Next, at step 1704, the operator will remove only those blade mounting bolts which need to be removed to attach the descent cables (cables 104) to the blade. In some embodiments, no bolts will need to be removed because the blade may be provided with special attachment features such as rings or threaded attachment holes or bolt heads. These may be provided, for example, on the upper side of the blade attachment collar, or the interior facing edge of the blade attachment collar.

Referring still to FIG. 17, after the descent cables have been attached to the blade attachment collar at step 1706, the operator takes a slack in the cables until they all bear an equal tension, and until they bear an appropriate tension to remove the remaining mounting bolts holding the blade to the hub. These bolts are removed at step 1708.

At this point, the blade is ready to be lowered by extending all 4 of the cables at an equal pace (step 1710). To complete the lowering process, when the blade is descended far enough for the lower end to be captured at ground level, it should be captured and pulled horizontally with a truck or other equipment so that the blade is lowered to a flat position on the ground. To avoid interference with the tower, the blade should be pulled along the propeller spin path direction, and not toward or away from the front of the tower. The descending end of the blade may be captured at one end of a transport truck and the blade lowered into position directly on the transport truck. For servicing at ground level, the blade may simply be lowered to the ground.

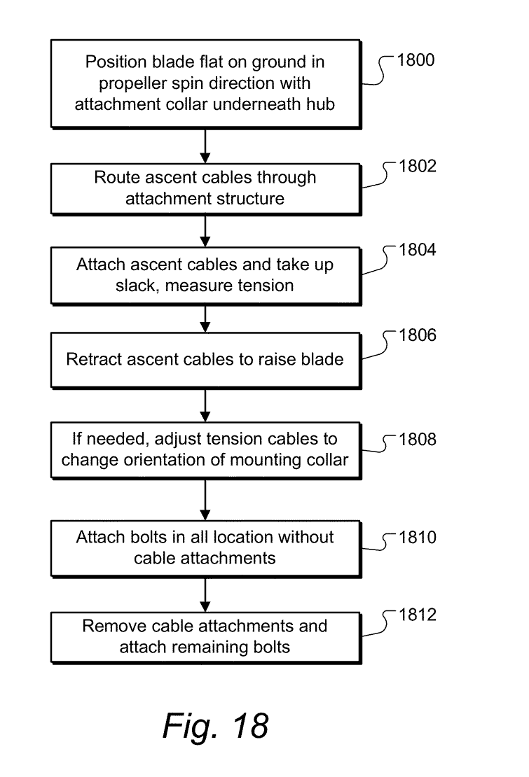

FIG. 18 is a flowchart of a process for raising and attaching a turbine blade according to one embodiment. The depicted process begins at step 1800, where the blade desired to be raised is placed in front of the tower flat on the ground or on a truck or other equipment, with the attachment collar underneath the hub to prevent any unnecessary swaying of the blade as it is raised. A wheeled attachment or protective cover may be placed at the other end of the blade to avoid damaging the blade by dragging it on the ground. The blade raising or lowering system is installed in the tower as previously described. At step 1802, the cables 104, this time referred to as ascent cables because they are raising the blade, are routed through the attachment holes or other attachment structure in the hub and lowered to the ground level. Next, at step 1804, the ascent cables are attached to the blade mounting collar, and all slack in the cables taken up until all the cables bear the same tension. At this point, the blade is ready to raise for mounting to the rotor hub. At step 1806, the center cables are retracted to raise the blade. As the blade is raised, and the attachment bolts on the blade mounting collar move near the blade attachment opening of the hub, the use of cables that pass through the mounting bolt holes on the hub, or pass through some structure in a fixed position relative to those holes insures that the blade rotation and position is adjusted automatically for easily fitting the bolts into the mounting holes. If adjustment is needed (step 1808), it may be accomplished by slightly varying the tension of one or more (preferably two) cables together in order to adjust the angle of vertical of the blade, or adjust rotation of the blade. Next, at step 1810, all of the attachment bolt locations that are not configured with a cable are attached, typically by securing the bolt with washers along the upper side edges of the blade mounting opening. Finally, at step 1812, the process removes the cable attachments from the blade and attaches any remaining mounting bolts, again typically by securing them with nuts. At this point, the blade is mounted without the use of a crane.

As will become apparent to one of ordinary skill in the art and viewing the disclosed embodiments, further variations for applying the techniques herein to tower maintenance platforms are possible and are within the scope of the appended claims. The above described preferred embodiments are intended to illustrate the principles of the invention, but not to limit the scope of the invention. Various other embodiments and modifications to these preferred embodiments may be made by those skilled in the art without departing from the scope of the invention.

1. A wind tower climbing vehicle comprising:
a platform for carrying a payload, the platform including a central opening designed to fit around a tower's central column, the platform including a first gripping device adapted to removably secure the platform to the tower central column;
a support assembly including a second gripping device adapted to removably secure the support assembly to the tower central column; and
at least one mechanical lifting device connected between the platform and the support assembly, the mechanical lifting device adapted to lift the platform in a first lifting motion away from the support assembly to achieve an expanded position, the mechanical lifting device further adapted to lift the support assembly in a second lifting motion toward the platform to achieve a contracted position.

2. The vehicle of claim 1 in which the first gripping device is an iris clamp.

3. The vehicle of claim 2 wherein the iris clamp comprises a plurality of claim blades driven by respective hydraulic pistons.

4. The vehicle of claim 1 wherein the mechanical lifting device comprises at least one scizzor-lift jack.

5. The vehicle of claim 1 wherein the platform includes a deck adapted to carry the payload, the deck further adapted to move, expand, or extend toward the tower central column to close a gap between the deck and the tower central column created by the vehicle climbing to a height where the tower central column is narrower than it is at a base height.

6. The vehicle of claim 1 wherein the vehicle is adapted to carry wind turbine bearings to the top of wind towers.

7. A wind tower climbing vehicle comprising:
a platform for carrying a payload, the platform including a central opening designed to fit around a wind tower; and
a mechanical clamping and lifting arrangement provided about the central opening of the platform, the mechanical clamping and lifting arrangement adapted to lift the platform while maintaining an inward clamping pressure against the wind tower exterior.

8. The vehicle of claim 7 wherein the platform includes a deck adapted to carry the payload, the deck further adapted to move, expand, or extend toward a tower central column to close a gap between the deck and the wind tower created by the vehicle climbing to a height where the wind tower is narrower than it is at a base height.

9. The vehicle of claim 7 wherein the mechanical clamping and lifting arrangement further comprises a set of wheels adapted to apply the clamping pressure against the wind tower exterior and adapted to rotate to lift the wind tower.

10. The vehicle of claim 9 wherein the set of wheels includes multiple groups of wheels, each group positioned at a different circumferential position about the central opening, each group including at least an upper wheel and a lower wheel positioned vertically below the upper wheel.

11. The vehicle of claim 9 wherein the set of wheels is adapted to move inward in a radial direction relative to the wind tower in order to maintain pressure on the wind tower exterior as the vehicle climbs the wind tower.

12. The vehicle of claim 7 wherein the vehicle is adapted to carry wind turbine bearings to the top of wind towers.

13. The vehicle of claim 7 further comprising a gap formed in the platform in a position to allow the platform to pass a wind turbine propeller blade held in a vertical position.

14. The vehicle of claim 13 in which the gap is further adapted to allow passage of wind turbine propeller blades while the propeller is rotating.

15. The vehicle of claim 13 in which the gap is positioned to allow maintenance of the propeller blade from the vehicle.

16. A method of raising or lowering a blade from a wind turbine tower, the method comprising:
attaching three or more cables to a blade attachment collar through an interior of a wind turbine tower hub;
after attaching the three or more cables, providing tension on the cables;
disconnecting or connecting a plurality of mounting bolts on the blade attachment collar from an attachment portal of the wind turbine tower hub; and
operating one or more winches to let out or take up the three or more cables to respectively lower or raise the blade.

17. The method of claim 16, further comprising passing the one or more cables through a pulley assembly located inside the wind turbine tower hub.

18. The method of claim 17, further comprising moving the pulley assembly into the wind tower turbine hub through a hub access portal in pieces, and then assembling the pulley assembly inside the wind tower turbine hub and securing it in place therein.

19. The method of claim 16, further comprising fixing the one or more winches in place inside the wind turbine tower hub.

20. The method of claim 16, in which attaching the three or more cables to the blade attachment collar further comprises passing the three or more cables through respective mounting holes configured to receive mounting bolts from the blade attachment collar.
